(19) United States
(12) Patent Application Publication
(10) Pub. No.: US 2026/0195712 A1
(43) Pub. Date: Jul. 9, 2026

(54) BIAS-FREE FUNNELING FOR EMPLOYMENT-FOCUSED ONLINE PLATFORMS

(71) Applicant: Andrew Stewart, Honolulu, HI (US)

(72) Inventor: Andrew Stewart, Honolulu, HI (US)

(21) Appl. No.: 19/012,821

(22) Filed: Jan. 7, 2025

(51) Int. Cl. G06Q 10/1053; G06N 20/00

(52) U.S. Cl. CPC G06Q 10/1053; G06N 20/00

(57) ABSTRACT

A computer-implemented method for an employment-focused platform includes performing automated online funneling on a group of job seekers to select a subgroup of the job seekers as job candidates for consideration for employment. The funneling is performed prior to considering any personal information about the job seekers. The funneling includes administering a scientific soft skills test online to each job seeker, and applying at least one trained machine learning (ML) model to results of each test to rank the job seekers for at least one job posting.

### FIELD

The present technology is related to hardware and, more specifically to employment-focused online platforms.

### BACKGROUND

Employment-focused websites such as LinkedIn and Indeed enable job seekers to connect with job posters. Typically, a job seeker learns of a job posting through an employment-focused website. If that job posting is of interest, the job seeker submits a resume.

A typical resume lists hard skills of the job seeker. Hard skills, sometimes referred to as technical skills, are technical knowledge or training gained through life experience. Examples of hard skills include education, work experience, and job-related skills.

Some resumes also list subjective soft skills. Subjective soft skills refer to a job seeker's personal assessment of their own personal habits and traits that shape how they work alone and with others. Examples of subjective soft skills include effective communication, dependability, effective teamwork and active listening.

If a large number of job seekers respond to a job posting, the resume is used as the primary source of funneling. Funneling refers to the process of narrowing the number of job seekers to the next stage of the hiring process. The next stage may involve testing and interviews.

Getting to that next stage often involves factors other than merit. Confirmation bias can be a factor. Skillful resume drafting, whether by a professional or artificial intelligence, can also be a factor.

### SUMMARY

In accordance with various embodiments and aspects herein, a computer-implemented method for an employment-focused platform includes performing automated online funneling on a group of job seekers to select a subgroup of the job seekers as job candidates for consideration for employment. The funneling is performed prior to considering any personal information about the job seekers. The funneling includes administering a scientific soft skills test online to each job seeker, and applying at least one trained machine learning (ML) model to results of each test to rank the job seekers for at least one job posting.

In accordance with various embodiments and aspects herein, a computer system includes a processing unit and computer-readable memory encoded with executable code. The code, when executed, causes the processing unit to perform automated online funneling on a group of job seekers to select a subgroup of the job seekers as job candidates for consideration for employment. The funneling is performed prior to considering any personal information about the job seekers. The funneling includes administering a scientific soft skills test online to each job seeker, and applying at least one trained machine learning (ML) model to results of each test to rank the job seekers.

In accordance with various embodiments and aspects herein, a product includes computer-readable memory encoded with executable code that, when executed, causes a processing unit to perform automated online funneling on a group of job seekers to select a subgroup of the job seekers as job candidates for consideration for employment. The funneling is performed prior to considering any personal information about the job seekers. The funneling includes administering a scientific soft skills test online to each job seeker, and applying at least one trained machine learning (ML) model to results of each test to rank the job seekers.

### BRIEF DESCRIPTION OF THE DRAWINGS

In order to understand methods, systems and products herein more fully, reference is made to the accompanying drawings. The methods, systems and products herein are described in accordance with the aspects and embodiments in the following description with reference to the drawings or figures, in which like numbers represent the same or similar elements. Understanding that these drawings are not to be considered limitations in the claimed scope of the methods, systems and products, the presently described aspects and embodiments of the methods, systems and products are described with additional detail through use of the accompanying drawings.

FIG. 1 is an illustration of a computer-implemented method for performing online funneling on a group of job seekers to select a subgroup of the job seekers as job candidates.

FIG. 2 is an illustration of a computer-implemented method for an employment-focused online platform.

FIG. 3 is an illustration of a front end and a back end of an employment-focused online platform.

FIG. 4 is an illustration of a computing environment for an employment-focused online platform.

### DETAILED DESCRIPTION

The following describes various examples of the present technology that illustrate various aspects and embodiments herein. Generally, examples can use the described aspects in any combination. All statements herein reciting principles, aspects, and embodiments as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

It is noted that, as used herein, the singular forms “a,” “an” and “the” include plural referents unless the context clearly dictates otherwise. Reference throughout this specification to “one embodiment,” “an embodiment,” “certain embodiment,” “various embodiments,” or similar language means that a particular aspect, feature, structure, or characteristic described in connection with the embodiment is included in at least one embodiment herein.

Thus, appearances of the phrases “in one embodiment,” “in at least one embodiment,” “in an embodiment,” “in certain embodiments,” and similar language throughout this specification may, but do not necessarily, all refer to the same embodiment or similar embodiments. Furthermore, aspects and embodiments described herein are merely exemplary, and should not be construed as limiting of the scope or spirit of the claims as appreciated by those of ordinary skill in the art. Furthermore, to the extent that the terms “including”, “includes”, “having”, “has”, “with”, or variants thereof are used in either the detailed description and the claims, such terms are intended to be inclusive in a similar manner to the term “comprising.”

As used herein, the term “online” refers to an activity or serviced that is available on or performed using the Internet or other computer network.

As used herein, an “employment-focused online platform” refers to an online platform that is associated with connecting job seekers with one or more potential employers. The platform is not limited to any particular service. As a first example, the employment-focused platform hosts an employment-focused social media website. As a second example, the employment-focused platform hosts a company website, which has a page for job postings. As a third example, the employment-focused platform hosts a service that screens job seekers on behalf of potential employers.

As used herein, a “job seeker” is a person who has expressed an intent to find a job or change jobs. As a first example, a job seeker might express that intent by contacting a prospective employer directly. As a second example, a job seeker might express that intent by responding to a job post on an employment-focused website. As a third example, a job seeker might express that intent by seeking employment through a third party (e.g., professional recruiter).

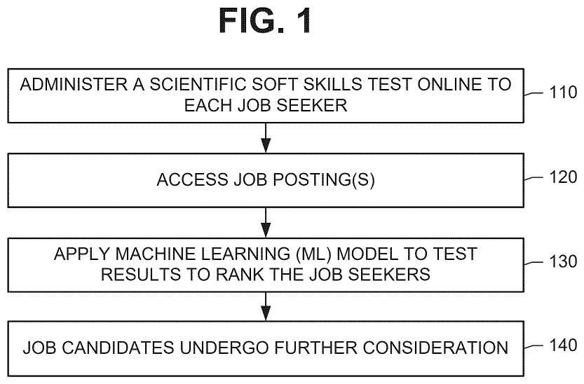

Reference is made to FIG. 1, which illustrates a computer implemented method for an employment-focused platform. The method includes performing automated online funneling on a group of job seekers to select a subgroup of the job seekers as job candidates for consideration for employment. The funneling is performed prior to considering any personal information (e.g., photos, resumes) about the job seekers.

At block 110, a scientific soft skills test is administered online to each job seeker. The scientific soft skills test does not include a personal assessment of the test takers skills. Rather, it is test that has been proven to accurately predict the test taker's performance, productivity and team/cultural fit. One such test is the Johnson IPIP-NEO-120 soft skills assessment (120 is the number of statements in the test). Each statement in the test has been scientifically linked (based on a school of Psychology called Industrial/Organizational Psychology) to a specific soft skill that is critical for job performance, productivity and team/cultural fit.

Another such test is a modification of the Johnson IPIP-NEO-120 soft skills assessment. A number of statements (e.g., 50 to 300 statements) are grouped into pairs based on a “response theory” using social desirability/acceptance as the pairing mechanism for the statements. For example, 100 statements are paired into 50 statement pairs. For each statement pair, the job seeker is forced to choose one of the statements as the statement that is “most like them” instead of rating the statement on a Likert Scale (strongly agree, somewhat agree, neither agree nor disagree, somewhat agree, strongly disagree). Some statements are positive (e.g., things we'd all like to be associate with) and other statements are negative (not anything we'd want to be associated with).

In some embodiments, the soft skills statements may be broken down into domains, such as openness to experience, conscientiousness, extraversion, agreeableness, and neuroticism. In some embodiments, each domain may be further broken down into facets. Facets of openness may include imagination, artistic interests, emotionality, adventurousness, intellect and liberalism. Facets of conscientiousness may include self-efficacy, orderliness, dutifulness, achievement striving, self-discipline, and cautiousness. Facets of extraversion may include friendliness, gregariousness, assertiveness, activity level, excitement seeking, and cheerfulness. Facets of agreeableness may include trust, morality, altruism, cooperation, modest, and sympathy. Facets of neuroticism may include anxiety, anger, depression, self-consciousness, immoderation, and vulnerability.

The statements may be answered using a force choice format based (e.g., yes/no, agree/disagree) on “response theory.” Job seekers are forced to choose one statement from an equally positive or negative set of statements. Paired statements are advantageous because they make it difficult for a job seeker to overexaggerate or underexaggerate their feelings about a statement and thereby skew the results of their soft skills responses.

The following is but one example of a statement pair.

Select the statement that is most like you:
Have a lot of fun.
Keep my promises.

The statement “have a lot of fun” is directly associated with the domain Extraversion domain and, more specifically, the Cheerfulness facet. The statement “keep my promises” is associated with the Conscientiousness domain and, more specifically, the dutifulness facet.

The soft skills test may be completely randomized in its presentation. For instance, no two tests are ever be presented in the same order to anyone.

In some embodiments, the soft skills test may be industry-specific or role-specific, and the same test may be administered to all of the job seekers in a particular industry. In some embodiments, the same test may be given to all job seekers across multiple industries. In some embodiments, the same soft skills tests are administered across different industries, but different skill groups tested by the soft skills tests are weighted per industry, role, and seniority level. For example, agreeability might be weighted higher for a person in customer service than for a trial attorney.

Results of the soft skills tests are saved. For example, each job seeker may have a profile, and the results of the soft skills test are added to the profile. The profile may be linked to the job seeker by an anonymous unique identifier, but does not contain any personal information about the job seeker.

At block 120, at least one job posting is accessed. Each job posting may include company information and a set of job requirements (e.g., industry, company type, company size, department, seniority level, management responsibility, years of role experience, total experience, education level, security clearance). The job requirements may also identify preferred soft skills.

At block 130, at least one trained machine learning (ML) model is applied to results of each test to rank the job seekers for at least one job posting. In some embodiments, a plurality of job seekers apply for a specific job posting, and the goal of the funneling is to rank the plurality of job seekers for that job posting, and select the highest ranked job seekers as candidates for further consideration (e.g., an interview). In accordance with some aspects and embodiments, the highest ranked job seekers fall within the top rankings. In accordance with some aspects of the invention, the top ranking candidates may be a number of the top applicants, rather than just a percentage of the top applicants. For example, if there are 50 applicants, then all 50 applicants may be presented for consideration, resulting in 100% of the applicants being candidates. For another example, if there are 500 applicants, then the top 50 applicants may be presented for consideration, which results in up to 50 of the top applicants being the top 10%. In accordance with some aspects of the invention, a hiring manager could be looking for something very unique. The system may identify only 2 or 3 people with the unique qualifications or profile on the platform; this means that the two or three matches would be 100% of the highest ranked candidates. The system attempts to present a maximum of job seekers to a hiring manager, such as up to 50 candidates or job seekers. Thus, depending on the job opening and total number of candidates that match the highest rank candidates can be anywhere from <1% up to 100%.

In accordance with some aspects of the invention, the system provides the hiring manager with the top best matches, such as the top 50 best matches. This “top 50” list is constantly being refreshed or updates by the system (every 12 hours) based on candidates/job seekers agreeing to opt-in to interview (accepting their match with a hiring manager), or opt-out of the search (declining their match with the hiring manager), and/or if the hiring manager edits their job opening after posting the search on the fair pair platform. The process of updating the top candidates can also be filtered using a ML model that is trained using input from a hiring manager. The input for any number of hiring managers can be used, especially if the hiring managers control hiring for similar jobs, such that one candidate could be qualified for the different job based on the job criteria or requirements.

In other embodiments, the goal of the funneling is to perform an automatic search for each job seeker. Every job seeker is considered for every job posting. Thus, for each job seeker, at least one ML model is applied to each job posting and the test results to rank the job seeker. In this manner, the method can find the best candidates for each job posting.

An ML model may use a supervised learning algorithm. Training data for the ML model may be based on answers from previously-taken tests. For example, an employer may take the soft skills test and provides answers that would be considered ideal, or valued employees could take the soft skills tests.

At block 140, the job candidates undergo further consideration. Further consideration may include a background check, skills testing, profile verification, and one or more interviews. This may involve a double opt-in process. The job seeker accepts match (the first opt-in), and a company representative (e.g., a hiring manager) provides details for further consideration (e.g., a time and date of an interview) (the second opt-in).

The method of FIG. 1 offers several advantages over resume-based funneling, including greater computational efficiency. The method of FIG. 1 has less information to ingest and process, yet produces more accurate results than a resume and interviews. Greater accuracy reduces search time. Results are also more consistent.

The method of FIG. 1 eliminates personal bias from the funneling decisions. No personal data about a job seeker is considered. This further reduces the amount of information to ingest and process.

For the embodiments in which an automated search is performed, computational resources are further conserved. Computer resources are not wasted by searching for job postings and processing responses to job postings that will lead nowhere.

Submitting a profile for automatic searching offers further advantages. Rather than tailoring the answers to a specific job posting, the job seeker is not under any pressure to respond. Answers will tend to be more truthful. This will create the best possible matches between job seekers and hiring managers.

Resumes and other self-reporting documents are eliminated from the funneling. Not only does this reduce the amount of information to be processed up front, it also eliminates skillful resume drafting, whether by a professional or artificial intelligence.

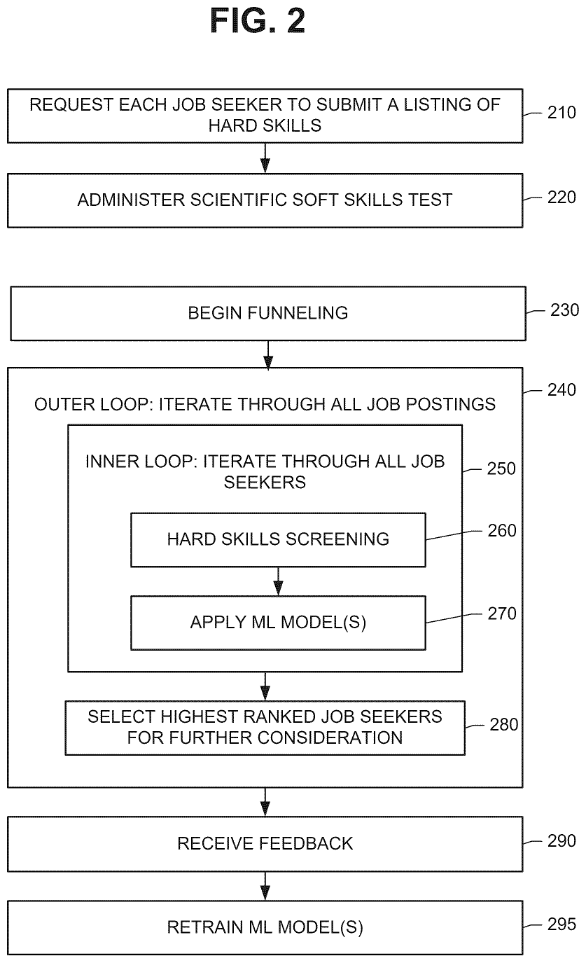

Reference is made to FIG. 2, which illustrates a computer-implemented method having some additional features. The method of FIG. 2 is described in connection with an employment-focused online platform that performs an automated search in which every job seeker is considered for every job posting.

Employers may register with the platform by submitting employer profiles. An employer profile may include, for example, hiring goal, department, responsibility, location, compensation and benefits, and type of working environment.

Job seekers may register with the platform via a mobile device (e.g., a tablet, a cell phone) or a desktop computer. A profile is created for each job seeker that registers.

At block 210, the platform requests each job seeker to submit a listing of their hard skills. As a first example, the job seeker fills out a form listing hard skills without any mention of employers, schools, or any other personal information. As a second example, the job seeker submits a resume, and the platform runs a program that scrubs all personal information from the resume and generates a listing of technical skills. The technical skills are added to the job seeker's profile.

At block 220, the platform administers a soft skills test to each job seeker. Test results are added to the job seeker's profile.

Blocks 210-220 may be performed for each job seeker that registers with the platform and completes their profile.

At block 230, the platform begins the funneling. Every job seeker who registered on the platform is considered for every job posting that is created on the platform. This may be performed by iterating through each job posting, and, for each job posting, iterating through all of the candidates.

Let N be the total number of job postings, and M be the total number of job seekers. At block 240, an outer loop is performed to iterate through all job postings for n=1 to N.

At blocks 250, an inner loop is performed to iterate through all job seekers for m=1 to M. At block 260, the platform uses the hard skills to screen the m^{th} job seeker for the n^{th} job posting. If the submitted hard skills indicate that the job seeker lacks basic qualifications for the job posting, that job seeker is immediately rejected. The screening is performed without considering any personal information about the job seeker. An ML model may be used to perform the screening and generate a hard skills score. In some instance, a hard skills score may be used only to eliminate a job seeker from consideration. In other instances, the hard skills score may be used primarily to eliminate unqualified job seekers and secondarily to help rank those job seekers that are not eliminated from consideration.

At block 270, an ML model is applied to the test results of the m^{th} job seeker and the n^{th} job posting. The ML model may generate a soft skills score for the m^{th} job seeker and the n^{th} job posting.

After all iterations in the loop have been performed, there is a soft skills score and optionally a hard skills score for each job seeker with respect to each job posting. In some instances, however, it might be desirable to evaluate the job seekers for a particular job or a particular set of jobs. In that case fewer than N iterations will be performed. If only a single job posting is under consideration, the inner loop is performed only once.

At block 280, the platform selects the highest ranked job seeker(s) for further consideration for the n^{th} job posting. In some instances, further consideration might include job interviews, skills testing, etc. In those embodiments that use a double opt-in process, the job seeker accepts a match, and a company representative (e.g., a hiring manager) provides details for further consideration. A match allows a hiring manager to review the job seekers work history, relevant experience, compensation (compared to their job posting) and benefits. A profile picture, name, and age of the job seeker are not available; therefore, a decision is based on the strength of the match.

In other embodiments, however, the platform selects the highest ranked candidate and automatically makes a job offer (or selects the highest ranked candidates and make multiple offers if multiple openings are available). This eliminates any chance of bias in the hiring decision. If an offer is rejected, the platform may make an offer to the next highest candidate.

An ML model may be used to select the best candidate(s) for a specific job posting. Inputs to the ML model may include details of the specific job posting, as well as soft skills scores and optionally the hard skills scores of a job seeker. The hard skills scores may be weighted relative to the soft skills scores.

Another input to the ML model may include the profile of an ideal candidate. An “ideal candidate” profile may be generated from historical matches based on similar job postings. Yet another input may include search criteria for a job seeker. The search criteria may specify a certain industry, department, seniority level, management responsibilities, etc.

In some embodiments, inputs to the ML model for selecting the best candidate(s) may include hard skills instead of hard skills scores. The hard skills scores would be used for an initial screening.

The ML models produce scores that are dynamic. The scores are constantly changing based on the running of the ML models against any new job postings and against any existing job postings that have been modified. Scores can also change if a job seeker refines a job search or runs multiple searches in parallel (for example, searching for different job opportunities in different industries, departments, seniority levels, etc.).

To help a job seeker and an employer evaluate matches, the platform may produce “stack rankings.” For a candidate, a stack ranking may list job postings that were considered matches and sort the listed job postings according to a criteria. For instance, the listed job postings may be sorted according to compensation, from highest to lowest. For an employer, a stack ranking might list candidates for a particular job posting, and sort the candidates according to a criteria. For example, the candidates may be sorted according to requested compensation, from lowest to highest. The stack rankings may be constantly refreshed for those job seekers who reject job postings or fail to respond to matches after a certain amount of time. The stack rankings eliminate the need for each employer and job seeker to conduct their own search, thus reducing computational resources spent on searches. The stack ranking eliminates endless hours of scrolling and searching for fear of missing out on a better opportunity or candidate for both job seeker and hiring managers.

Soft skills domains and facets may be used as another search criteria for stack ranking. Soft skills searches may help job seekers find work faster by allowing the system to best match their soft skills, and help the hiring managers hone in very quickly where on job seekers possessing desired soft skills.

At block 290, after the selected candidates have undergone further consideration, feedback about the selected candidates is received. The feedback may provide an assessment of the performance of the selected candidates during interviews and skills testing. The feedback may provide an assessment of on-job performance of those candidates who accepted job offers.

In embodiments where a double opt-in is used, and a job candidate refuses to opt in, for example, because they don't like a match, the job seeker may be requested to provide feedback. Similarly, a hiring manager may be requested to provide feedback if they reject a match. If a match is accepted, positive feedback may be requested from the job seeker and/or the hiring manager.

At block 295, the feedback is used to supplement the training data, and the ML model(s) may be retrained on the supplemented training data. For example, the soft skill test results of each candidate may be added to the training set and labeled according to the feedback.

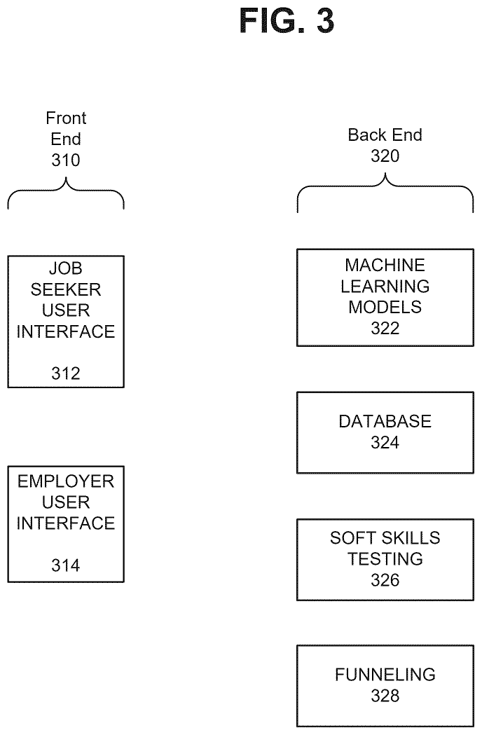

Reference is made to FIG. 3, which illustrates an example of a front end 310 and a back end 320 for the platform. The front end 310 is what users see and interact with. The users include a plurality of job seekers and a plurality of employers. The front end 310 include graphical user interfaces (GUIs) 312 for the job seekers and graphical user interfaces 314 for the employers.

The back end 320 is how everything works behind the scenes. In some embodiments, such as the example illustrated in FIG. 3, the back end 320 includes machine learning models 322, a database 324, soft skills testing 326, and funneling 328. In other embodiments, the machine learning models 322, the database 324 and/or the soft skills testing 326 are not part of the platform, but rather are provided as a service to the platform.

Different machine learning models 322 using different types of algorithms may perform the various functions. ML models for screening the hard skills at block 260 may be include gradient boosting models, support vector machines and neural networks. ML models applied to the soft skills test results at block 270 may include fully-connected neural networks and Bidirectional Encoder Representations from Transformers (BERT) models. ML models for selecting the highest ranked job seekers at block 280 may include collaborative filtering (matrix factorization), content-based filtering, and graph neural networks (GNNs).

A single machine learning model may be trained to perform block 260 across different industries, a single machine learning model may be trained to perform block 270 across different industries, and a single ML model may be trained to perform block 280 across different industries. However, greater computational efficiency and accuracy can be achieved by using industry-specific models at each of blocks 260, 270 and 280. For example, the ML models for performing block 260 might include a model that is trained on hard skills specific to lawyers, another model that is trained on hard skills specific to accountants, another model that is trained on hard skills specific to biologists, another model that is trained on hard skills specific to computer programmers, and so on.

The database 324 may store profiles of different employers and profiles of different job seekers. In some embodiments, the employer profiles and job seeker profiles are non-searchable and names are kept confidential.

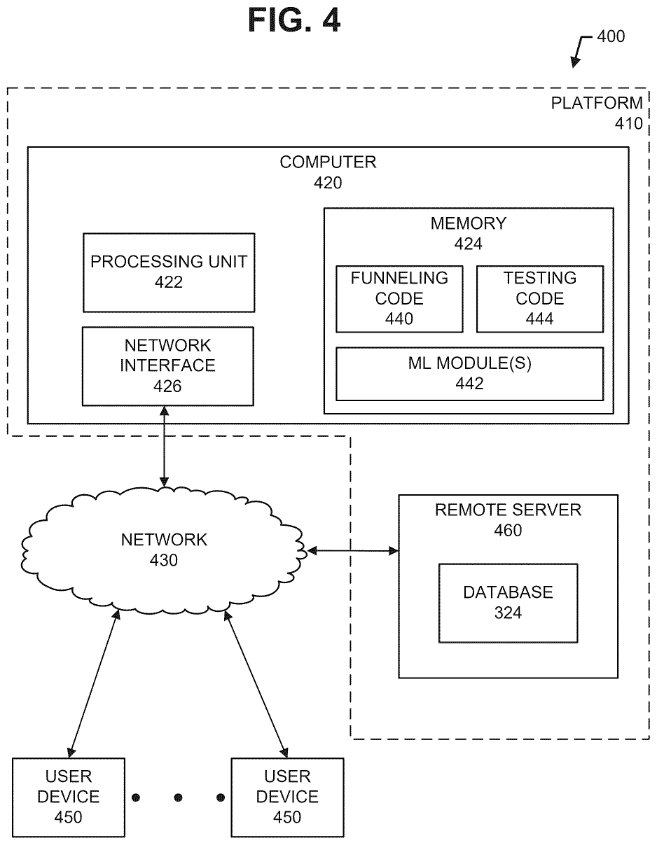

Reference is made to FIG. 4, which illustrates an example computing environment 400 including an online employment-focused platform 410. The platform 410 includes a computer 420. The computer 420, in turn, includes a processing unit 422, computer-readable memory 424, and a network interface 426.

The network interface 426 provides access to a network 430. The network 430 may include one or more of a local area network and a wide area network. The network 430 may also provide access to additional computing resources in a public cloud or private cloud (collectively, “the cloud”).

The computer-readable memory 424 stores computer-readable code 440 that, when executed, causes the processing unit 422 to perform the funneling 328. The example computing environment 400 also shows the memory 424 as storing a module 442 including the ML models 322 and code for using and training the ML models 322, and a code 444 for administering the soft skills testing 326. In other embodiments, the module 442 and testing code 444 are not stored on the computer 420. Instead, the ML models 322 and the soft skills testing 326 are accessed as services via the network 430.

A plurality of user devices 450 communicate with the computer 420 via the network 430. Examples of the user devices 450 include desktop computers, tablets and smart phones. End user devices 450 of the job seekers include GUIs 312, and end user devices 450 of the employers include GUIs 314.

A remote server 460 maintains the database 324. A remote server 460 may also host an employment-focused website.

Certain examples have been described herein and it will be noted that different combinations of different components from different examples may be possible. Salient features are presented to better explain examples; however, it is clear that certain features may be added, modified and/or omitted without modifying the functional aspects of these examples as described.

Certain methods according to the various aspects of the invention may be performed by instructions that are stored upon a non-transitory computer readable medium. The non-transitory computer readable medium stores code including instructions that, if executed by one or more processors, would cause a system or computer to perform steps of the method described herein. The non-transitory computer readable medium includes: a rotating magnetic disk, a rotating optical disk, a flash random access memory (RAM) chip, and other mechanically moving or solid-state storage media. Any type of computer-readable medium is appropriate for storing code comprising instructions according to various example.

Various examples are methods that use the behavior of either or a combination of machines. Method examples are complete wherever in the world most constituent steps occur. For example, IP elements or units include: processors (e.g., CPUs or GPUs), random-access memory (RAM—e.g., off-chip dynamic RAM or DRAM), a network interface for wired or wireless connections such as ethernet, WiFi, 3G, 4G long-term evolution (LTE), 5G, and other wireless interface standard radios. The IP may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices processors perform steps of methods as described herein.

Some examples are one or more non-transitory computer readable media arranged to store such instructions for methods described herein. Whatever machine holds non-transitory computer readable media comprising any of the necessary code may implement an example. Some examples may be implemented as: physical devices such as semiconductor chips; hardware description language representations of the logical or functional behavior of such devices; and one or more non-transitory computer readable media arranged to store such hardware description language representations. Descriptions herein reciting principles, aspects, and embodiments encompass both structural and functional equivalents thereof. Elements described herein as coupled have an effectual relationship realizable by a direct connection or indirectly with one or more other intervening elements.

Practitioners skilled in the art will recognize many modifications and variations. The modifications and variations include any relevant combination of the disclosed features. Descriptions herein reciting principles, aspects, and embodiments encompass both structural and functional equivalents thereof. Elements described herein as “coupled” or “communicatively coupled” have an effectual relationship realizable by a direct connection or indirect connection, which uses one or more other intervening elements. Embodiments described herein as “communicating” or “in communication with” another device, module, or elements include any form of communication or link and include an effectual relationship. For example, a communication link may be established using a wired connection, wireless protocols, near-field protocols, or RFID.

To the extent that the terms “including”, “includes”, “having”, “has”, “with”, or variants thereof are used in either the detailed description and the claims, such terms are intended to be inclusive in a similar manner to the term “comprising.”

The scope of the invention, therefore, is not intended to be limited to the exemplary embodiments shown and described herein. Rather, the scope and spirit of present invention is embodied by the appended claims.

What is claimed is:

1. A computer-implemented method for an employment-focused platform, the method comprising:
performing automated online funneling on a plurality of job seekers to select a subgroup of the plurality of job seekers as job candidates for consideration for employment, wherein the automated online funneling is performed prior to considering any personal information about the plurality of job seekers; and
wherein the automated online funneling includes:
administering a scientific soft skills test online to each job seeker; and
applying at least one trained machine learning (ML) model to results of each soft skills test to rank the subgroup of the plurality of job seekers for at least one job posting.

2. The method of claim 1, wherein the soft skills test includes a plurality of paired statements that are paired using social desirability and acceptance as a pairing mechanism and the plurality of job seekers are forced to choose one of the statements in each pair as the statement that is most like them.

3. The method of claim 2, wherein the soft skills test covers different domains and facets within the domains.

4. The method of claim 2, wherein the soft skills test is administered to all of the job seekers, but are weighted per industry, role, and seniority level.

5. The method of claim 1, wherein the funneling further includes selecting highest ranked job seekers as the job candidates.

6. The method of claim 1, wherein there are plurality of job postings, and wherein each job seeker is considered for each of the plurality of job postings.

7. The method of claim 1, further comprising receiving technical skills of the job seekers prior to the funneling, and eliminating those job seekers lacking requisite technical skills prior to the funneling.

8. The method of claim 7, wherein at least one first ML model using a first type of algorithm is used to eliminate those job seekers lacking requisite technical skills and at least one second ML model using a second type of algorithm is applied to the results of the soft skills test.

9. The method of claim 8, wherein the first ML model and the second ML model are industry-specific.

10. The method of claim 1, further comprising obtaining feedback about the job candidates and using the feedback to retrain the ML model.

11. The method of claim 1, wherein the job candidates are stack ranked.

12. A computer system comprising:
a processing unit; and
computer-readable memory encoded with executable code that, when executed, causes the processing unit to perform online funneling on a group of job seekers to select a subgroup of the job seekers as job candidates for consideration for employment, wherein the funneling is performed prior to considering any personal information about the job seekers; and wherein the funneling includes administering a soft skills test online to each job seeker; and applying at least one trained machine learning (ML) model to results of each test to rank the job seekers.

13. The system of claim 12, wherein the soft skills test includes a plurality of paired statements that are paired using social desirability and acceptance as a pairing mechanism; and wherein the job seekers are forced to choose one of the statements in each pair that is most like them.

14. The system of claim 13, wherein at least one ML model using a first type of algorithm is used to eliminate those job seekers lacking requisite technical skills, and at least one ML model using a second type of algorithm is applied to the results.

15. The system of claim 14, wherein the ML models are industry-specific.

16. The system of claim 15, wherein the executable code, when executed, further causes the processing unit to obtain feedback about at least some of the job candidates; and wherein the feedback is used to retrain the ML model.

17. A product comprising computer-readable memory encoded with executable code that, when executed, causes a processing unit to perform online funneling on a group of job seekers to select a subgroup of the job seekers as job candidates for consideration for employment, wherein the funneling is performed prior to considering any personal information about the job seekers; and wherein the funneling includes:
administering a soft skills test online to each job seeker; and
applying at least one trained machine learning (ML) model to results of each test to rank the job seekers.

18. The product of claim 17, wherein the soft skills test includes a plurality of paired statements that are paired using social desirability and acceptance as a pairing mechanism; and wherein the job seekers are forced to choose one of the statements in each pair that is most like them.

19. The product of claim 17, wherein at least one first ML model using a first type of algorithm is used to eliminate those job seekers lacking requisite technical skills and at least one second ML model using a second type of algorithm is applied to the results of the soft skills test.

20. The product of claim 19, wherein the first ML model and the second ML model are industry-specific.
